(19) United States
(12) Patent Application Publication
(10) Pub. No.: US 2016/0171728 A1
(43) Pub. Date: Jun. 16, 2016

(54) METHODS AND SYSTEMS FOR COMMUNICATING A SENSATION

(71) Applicant: VALIBER LTD., Holon (IL)

(72) Inventor: Yuval KLEIN, Holon (IL)

(73) Assignee: VALIBER LTD., Tel Aviv (IL)

(21) Appl. No.: 14/907,392

(22) PCT Filed: Jul. 15, 2014
(86) PCT No.: PCT/IL2014/050636

§ 371 Date: Jan. 25, 2016

Related U.S. Application Data
(60) Provisional application No. 61/857,724, filed on Jul. 24, 2013.

(51) Int. Cl. G06T 11/20; G09B 19/00

(52) U.S. Cl. CPC G06T 11/206; G09B 19/00; G09B 19/0092; G06T 2200/24

(57) ABSTRACT

Provided is a system for communicating the intensity of a sensation on a sensation intensity scale, characterized by: (a) a receiving module for obtaining at least two values of at least two different measurable parameters affecting said sensation; (b) a processing module for factorizing these two values into a scale-mark on the sensation intensity scale which is comprised of two or more scale-marks; (c) a GUI for presenting the sensation intensity scale and scale-mark; and (d) a communication module for sharing the scale-mark on the intensity scale.

### FIELD OF THE INVENTION

The present invention generally relates to methods and systems for communicating a sensation. More particularly, the present invention further pertains to method and system into which an intensity of a sensation is introduced and shared.

### BACKGROUND OF THE INVENTION

Sensations are a subjective matter. For example, a situation that makes one person sob leaves another person indifferent; a joke that makes one individual cry with laughter barely makes another individual smile; a cup of coffee sweetened with two spoons of sugar might be just right for some but disgustingly sweet to others.

Despite their subjectivity, sensations can be predicted quite accurately when taking into considerations factors such as gender, age, race, different habits and other parameters differentiating individuals. For example, it is known that the absolute perception decreases with age for all tastants (Taste Qualities? Jos Mojet, Johannes Heidema and Elly Christ-Hazelhof; Chem. Senses (2003) 28 (5): 397-413). Another known fact is that men are more easily bored than women (Scientific American, Anna Gosline, 2006). If these factors will be taken into consideration it will make it easier to predict perception of an individual.

Sensation can be also better predicted if the scenery in which they are located will be reflected. For example, the sensitivity to the tastes sweet, sour, and salty is decreased in the presence of fatty acids and is also affected by temperature. In a similar manner other sensations can be influenced by external factors.

In summary sensations could be predicted and graded and shared between individuals if they will be taken apart to measurable parameters. This will enable people to share their sensations and people could benefit from it as they would be able to accommodate the sensation of another person to themselves.

Therefore there is a long unfelt need for methods and systems for communicating sensations that make it possible to share the degree of different sensations in different mediums.

### SUMMARY OF THE INVENTION

The present invention provides a system for communicating the intensity of a sensation on a sensation intensity scale, characterized by: (a) a receiving module for obtaining at least two values of at least two different measurable parameters affecting the sensation; (b) a processing module for factorizing at least two values of different measurable parameters affecting the sensation into a scale-mark on the sensation intensity scale; the sensation intensity scale is comprised of two or more scale-marks; (c) a GUI. for presenting the sensation intensity scale and the scale-mark; and (d) a communication module for sharing the scale-mark on the intensity scale.

It is another object of the current invention to disclose the system as defined in any of the above, wherein at least two from the following group are the same device; the group is consisted of: (a) the receiving module; (b) the processing module; (c) the GUI and (d) the communication module.

It is another object of the current invention to disclose the system as defined in any of the above, further characterized by at least one measuring module for measuring at least two different measurable parameters affecting the sensation.

It is another object of the current invention to disclose the system as defined in any of the above, wherein at least one measuring module is selected from a group of electronic or electric measuring devices comprising of refractometer, VU meter, voltmeter, video signal generator, vectorscope, wattmeter, tube tester, transistor tester, sweep generator, pH electrode, spectrum analyser, Signal generator, Signal analyzer, Q meter, psophometer, oscilloscope, ohmmeter, network analyzer, microwave power meter, multimeter, LCR meter, Frequency counter, electricity meter, distortionmeter, capacitance meter, ammeter, thermometer, motion detector, metal detector; and any combination thereof.

It is another object of the current invention to disclose the system as defined in any of the above, wherein the measuring module is selected from a group consisting of electrode, lancet, sensor, detector, biosensor; and any combination thereof.

It is another object of the current invention to disclose the system as defined in any of the above, wherein the measuring module is disposable.

It is another object of the current invention to disclose the system as defined in any of the above, wherein the connection of the measuring module with the processing module is selected from a group consisting of: (a) remote; (b) direct; and any combination thereof.

It is another object of the current invention to disclose the system as defined in any of the above, wherein at least two values of at least two different measurable parameters affecting the sensation are manually inserted into the receiving module of the system.

It is another object of the current invention to disclose the system as defined in any of the above, wherein at least two values of at least two different measurable parameters affecting the sensation are automatically inserted into the receiving module of the system.

It is another object of the current invention to disclose the system as defined in any of the above, wherein at least two values of at least two different measurable parameters affecting the sensation are directly transmitted to the receiving module through at least one measuring module.

It is another object of the current invention to disclose the system as defined in any of the above, wherein at least two values of at least two different measurable parameters affecting the sensation are transmitted to the receiving module in a manner selected from a group consisting of: cable; WiFi; Bluetooth, IR, radio; and any combination thereof.

It is another object of the current invention to disclose the system as defined in any of the above, wherein the weight of each of at least two different measurable parameters when factorizing them to the scale-mark is selected from a group consisting of: (a) the weight of all the parameters are equal; (b) the weight of each of the parameters are different; and any combination thereof.

It is another object of the current invention to disclose the system as defined in any of the above, wherein the communication module is selected from a group consisting of: MP3 player; cellular phone; smartphone; tablet; laptop; computer; and any combination thereof.

It is another object of the current invention to disclose the system as defined in any of the above, wherein the GUI is selected from a group consisting of: MP3 player; cellular phone; smartphone; tablet; laptop; computer; and any combination thereof.

It is another object of the current invention to disclose the system as defined in any of the above, wherein the scale is selected from a group consisting of: interval scale; ratio scale; ordinal scale; and any combination thereof.

It is another object of the current invention to disclose the system as defined in any of the above, wherein the sensation is selected from a group consisting of vision, taste, hearing, smell, touch, reactions to external or internal stimuli, laughter, crying, blushing emotions, affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, flavors, sweet, sour, bitter, salty, umami, pungent or piquant, and metallic, and any combination thereof.

It is another object of the current invention to disclose the system as defined in any of the above, wherein the sensation is a flavor selected from a group consisting of sweet, sour, bitter, salty, umami, pungent or piquant, and metallic and any combination thereof.

It is another object of the current invention to disclose the system as defined in any of the above, wherein the sensation is a reaction to external or internal stimuli selected from a group consisting of: laughter, crying, blushing and any combination thereof.

It is another object of the current invention to disclose the system as defined in any of the above, wherein the sensation is an emotion selected from a group consisting of affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, and any combination thereof.

It is another object of the current invention to disclose the system as defined in any of the above, wherein the sensation is sweetness.

It is another object of the current invention to disclose the system as defined in any of the above, wherein at least two different measurable parameters are selected from a group consisting of: sugar concentration; temperature; acidity; color; color intensity; opacity; specific gravity; viscosity; and any combination thereof.

It is another object of the current invention to disclose the system as defined in any of the above, additionally comprising a feedback module.

It is another object of the current invention to disclose the system as defined in any of the above, wherein the feedback module directs the user how to change at least two values of at least two different measurable parameters to change the intensity of the sensation in specific way.

It is another object of the current invention to disclose the system as defined in any of the above, wherein the intensity of the sensation is graded in Val units.

It is another object of the current invention to disclose the system as defined in any of the above, wherein one Val unit is the threshold of the intensity of the sensation in which it is first acknowledged.

The present invention provides a sensation intensity scale for grading a sensation comprising a GUI presenting two or more scale-marks of the intensity of the sensation, the marks define different intensities of the sensation; wherein the intensity of the sensation factorizes at least two different measurable parameters affecting the intensity of the sensation.

It is another object of the current invention to disclose the sensation intensity scale as defined in any of the above, wherein the scale is selected from a group consisting of: interval scale; ratio scale; ordinal scale; and any combination thereof.

It is another object of the current invention to disclose the sensation intensity scale as defined in any of the above, wherein the GUI is selected from a group consisting of: MP3 player; cellular phone; smartphone; tablet; laptop; computer; and any combination thereof.

It is another object of the current invention to disclose the sensation intensity scale as defined in any of the above, wherein the sensation is selected from a group consisting of vision, taste, hearing, smell, touch, reactions to external or internal stimuli, laughter, crying, blushing emotions, affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, tear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, flavors, sweet, sour, bitter, salty, umami, pungent or piquant, and metallic, and any combination thereof.

It is another object of the current invention to disclose the sensation intensity scale as defined in any of the above, wherein the sensation is a flavor selected from a group consisting of sweet, sour, bitter, salty, umami, pungent or piquant, and metallic and any combination thereof.

It is another object of the current invention to disclose the sensation intensity scale as defined in any of the above, wherein the sensation is a reaction to external or internal stimuli selected from a group consisting of: laughter, crying, blushing and any combination thereof.

It is another object of the current invention to disclose the sensation intensity scale as defined in any of the above, wherein the sensation is an emotion selected from a group consisting of affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, and any combination thereof.

It is another object of the current invention to disclose the sensation intensity scale as defined in any of the above, wherein the sensation is sweetness.

It is another object of the current invention to disclose the sensation intensity scale as defined in any of the above, wherein at least two different measurable parameters are selected from a group consisting of: sugar concentration; temperature; acidity; color; color intensity; opacity; specific gravity; viscosity; and any combination thereof.

It is another object of the current invention to disclose the sensation intensity scale as defined in any of the above, wherein the intensity of the sensation is graded in Val units.

It is another object of the current invention to disclose the sensation intensity scale as defined in any of the above, wherein one Val unit is the threshold of the intensity of the sensation in which it is first acknowledged.

The present invention provides a measuring module for measuring at least two values of at least two different measurable parameters affecting the intensity of a sensation, comprising:

at least one sensor for obtaining at least two values; and

at least one transmitting component for transferring at least two values;

wherein the intensity of the sensation is factorized from at least two values.

It is another object of the current invention to disclose the measuring module as defined in any of the above, wherein the measuring module is dispensable.

It is another object of the current invention to disclose the measuring module as defined in any of the above, wherein at least one sensor is selected from a group of electronic or electric measuring devices comprising of refractometer, VU meter, voltmeter, video signal generator, vectorscope, wattmeter, tube tester, transistor tester, sweep generator, pH electrode, spectrum analyser, Signal generator, Signal analyzer, Q meter, psophometer, oscilloscope, ohmmeter, network analyzer, microwave power meter, multimeter, LCR meter, Frequency counter, electricity meter, distortionmeter, capacitance meter, ammeter, thermometer, motion detector, metal detector; and any combination thereof.

It is another object of the current invention to disclose the measuring module as defined in any of the above, wherein at least one sensor is selected from a group consisting of electrode, lancet, sensor, detector, biosensor; and any combination thereof.

It is another object of the current invention to disclose the measuring module as defined in any of the above, wherein at least one sensor is implemented in another device.

It is another object of the current invention to disclose the measuring module as defined in any of the above, wherein at least one sensor is introduced in a human cavity.

It is another object of the current invention to disclose the measuring module as defined in any of the above, wherein the measuring module measures in a time resolved manner.

It is another object of the current invention to disclose the measuring module as defined in any of the above, wherein the sensation is selected from a group consisting of vision, taste, hearing, smell, touch, reactions to external or internal stimuli, laughter, crying, blushing emotions, affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, flavors, sweet, sour, bitter, salty, umami, pungent or piquant, and metallic, and any combination thereof.

It is another object of the current invention to disclose the measuring module as defined in any of the above, wherein the sensation is a flavor selected from a group consisting of sweet, sour, bitter, umami, pungent or piquant, and metallic and any combination thereof.

It is another object of the current invention to disclose the measuring module as defined in any of the above, wherein the sensation is a reaction to external or internal stimuli selected from a group consisting of: laughter, crying, blushing and any combination thereof.

It is another object of the current invention to disclose the measuring module as defined in any of the above, wherein the sensation is an emotion selected from a group consisting of affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, honor, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, and. any combination thereof.

It is another object of the current invention to disclose the measuring module as defined in any of the above, wherein the sensation measured by at least one sensor is sweetness.

It is another object of the current invention to disclose the measuring module as defined in any of the above, wherein the intensity of the sensation is graded in Val units.

It is another object of the current invention to disclose the measuring module as defined in any of the above, wherein one Val unit is the threshold of the intensity of the sensation in which it is first acknowledged.

The present invention provides an article of manufacture (AOM) for measuring at least two values of at least two different measurable parameters affecting the intensity of a sensation, comprising: (a) at least one sensor for obtaining at least two values; and (b) at least one transmitting component for transferring at least two values; wherein the intensity of the sensation is factorized from at least two values.

It is another object of the current invention to disclose the AOM as defined in any of the above, selected from a group consisting of: item of clothing; cutlery; kitchenware; tableware; electric appliance; electronic appliance; vehicle; medical device; pharmaceuticals jewelry; synthetic transplant; and any combination thereof.

It is another object of the current invention to disclose the AOM as defined in any of the above, wherein the AOM is dispensable.

It is another object of the current invention to disclose the AOM as defined in any of the above, wherein at least one sensor is selected from a group of electronic or electric measuring devices comprising of refractometer, VU meter, voltmeter, video signal generator, vectorscope, wattmeter, tube tester, transistor tester, sweep generator, pH electrode, spectrum analyser, Signal generator, Signal analyzer, Q meter, psophometer, oscilloscope, ohmmeter, network analyzer, microwave power meter, multimeter, LCR meter, Frequency counter, electricity meter, distortionmeter, capacitance meter, ammeter, thermometer, motion detector, metal detector; and any combination thereof.

It is another object of the current invention to disclose the AOM as defined in any of the above, wherein at least one sensor is selected from a group consisting of electrode, lancet, sensor, detector, biosensor; and any combination thereof.

It is another object of the current invention to disclose the AOM as defined in any of the above, wherein at least one sensor is introduced in a human cavity.

It is another object of the current invention to disclose the AOM as defined in any of the above, wherein at least one sensor measures in a time resolved manner.

It is another object of the current invention to disclose the AOM as defined in any of the above, wherein the sensation is selected from a group consisting of vision, taste, hearing, smell, touch, reactions to external or internal stimuli, laughter, crying, blushing emotions, affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, flavors, sweet, sour, bitter, salty, umami, pungent or piquant, and metallic, and any combination thereof.

It is another object of the current invention to disclose the AOM as defined in any of the above, wherein the sensation is a flavor selected from a group consisting of sweet, sour, bitter, salty, umami, pungent or piquant, and metallic and any combination thereof.

It is another object of the current invention to disclose the AOM as defined in any of the above, wherein the sensation is a reaction to external or internal stimuli selected from a group consisting of: laughter, crying, blushing and any combination thereof.

It is another object of the current invention to disclose the AOM as defined in any of the above, wherein the sensation is an emotion selected from a group consisting of affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, and any combination thereof.

It is another object of the current invention to disclose the AOM as defined in any of the above, wherein the sensation measured by at least one sensor is sweetness.

It is another object of the current invention to disclose the AOM as defined in any of the above, wherein the intensity of the sensation is graded in Val units.

It is another object of the current invention to disclose the AOM as defined in any of the above, wherein one Val unit is the threshold of the intensity of the sensation in which it is first acknowledged.

The present invention provides a method for communicating the intensity of a sensation on a sensation intensity scale, comprising steps of: (a) obtaining a system for communicating the intensity of a sensation comprising a GUI presenting a scale of two or more scale-marks of the intensity of the sensation; the two or more scale-marks define different intensities of the sensation; (b) introducing to the system at least two values of at least two different measurable parameters affecting the intensity of the sensation; (c) receiving from the system one scale-mark of the intensity of the sensation; and (d)communicating the one scale-mark with an external source; wherein at least two values of different measurable parameters affecting the intensity of the sensation are factorized to the one scale-mark.

It is another object of the current invent on to disclose the method as defined in any of the above, additionally comprising a step of measuring at least two different measurable parameters affecting the sensation with at least one measuring module.

It is another object of the current invention to disclose the method as defined in any of the above, wherein the measuring module is disposable.

It is another object of the current invention to disclose the method as defined in any of the above, additionally comprising a step of selecting at least one measuring module from a group of electronic or electric measuring devices comprising of refractometer, VU meter, voltmeter, video signal generator, vectorscope, wattmeter, tube tester, transistor tester, sweep generator, pH electrode, spectrum analyser, Signal generator, Signal analyzer, Q meter, psophometer, oscilloscope, ohmmeter, network analyzer, microwave power meter, multimeter, LCR meter, Frequency counter, electricity meter, distortionmeter, capacitance meter, ammeter, thermometer, motion detector, metal detector; and any combination thereof.

It is another object of the current invention to disclose the method as defined in any of the above, additionally comprising a step of selecting at least one measuring module from a group consisting of electrode, lancet, sensor, detector, biosensor; and any combination thereof.

It is another object of the current invention to disclose the method as defined in any of the above, additionally comprising a step of manually inserting at least two values of at least two different measurable parameters affecting the sensation into the receiving module of the system.

It is another object of the current invention to disclose the method as defined in any of the above, additionally comprising a step of automatically inserting at least two values of at least two different measurable parameters affecting the sensation manually into the receiving module of the system.

It is another object of the current invention to disclose the method as defined in any of the above, additionally comprising a step of transmitting at least two values of at least two different measurable parameters affecting the sensation the receiving module directly through at least one measuring module for measuring at least two different measurable parameters.

It is another object of the current invention to disclose the method as defined in any of the above, additionally comprising a step of selecting a manner for transmitting at least two values of at least two different measurable parameters affecting the sensation to the receiving module in a manner selected from a group consisting of: cable; WiFi; Bluetooth, IR, radio; and any combination thereof.

It is another object of the current invention to disclose the method as defined in any of the above, additionally comprising a step of selecting the weight of each of at least two different measurable parameters when factorizing them to the scale-mark from a group consisting of: (a) the weight of all the parameters is equal; (b) the weight of each of the parameters is different; and any combination thereof.

It is another object of the current invention to disclose the method as defined in any of the above, additionally comprising a step of selecting the communication module from a group consisting of: MP3 player; cellular phone; smartphone; tablet; laptop; computer; and any combination thereof.

It is another object of the current invention to disclose the method as defined in any of the above, additionally comprising a step of selecting the GUI is selected from a group consisting of: MP3 player; cellular phone; smartphone; tablet; laptop; computer; and any combination thereof.

It is another object of the current invention to disclose the method as defined in any of the above, additionally comprising a step of selecting the scale from a group consisting of: interval scale; (b) ratio scale; (c) ordinal scale; and any combination thereof.

It is another object of the current invention to disclose the method as defined in any of the above, additionally comprising a step of selecting the external source from a group consisting of: social network; blog; interact site; individual; group of individuals; and any combination thereof.

It is another object of the current invention to disclose the method as defined in any of the above, wherein the step of sharing is carried out through a media selected from a group consisting of: (a) e-mail; (b) text message; (c) MMS; (d) upload to an interact website; and any combination thereof.

It is another object of the current invention to disclose the method as defined in any of the above, additionally comprising a step of selecting the sensation is selected from a group consisting of vision, taste, hearing, smell, touch, reactions to external or internal stimuli, laughter, crying, blushing emotions, affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, flavors, sweet, sour, bitter, salty, umami, pungent or piquant, and metallic, and any combination thereof.

It is another object of the current invention to disclose the method as defined in any of the above, additionally comprising a step of selecting the sensation from a group of flavors consisting of sweet, sour, bitter, salty, umami, pungent or piquant, and metallic and any combination thereof.

It is another object of the current invention to disclose the method as defined in any of the above, wherein the sensation is a reaction to external or internal stimuli selected from a group consisting of: laughter, crying, blushing and any combination thereof.

It is another object of the current invention to disclose the method as defined in any of the above, additionally comprising a step of selecting the sensation selected from a group of emotions consisting of affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest, and any combination thereof.

It is another object of the current invention to disclose the method as defined in any of the above, additionally comprising a step of selecting the sensation as sweetness.

It is another object of the current invention to disclose the method as defined in any of the above, additionally comprising a step of selecting at least two different measurable parameters from a group consisting of: sugar concentration; temperature; acidity; color; color intensity; opacity; specific gravity; viscosity; and any combination thereof.

It is another object of the current invention to disclose the method as defined in any of the above, wherein the intensity of the sensation is graded in Val units.

It is another object of the current invention to disclose the method as defined in any of the above, wherein one Val unit is the threshold of the intensity of the sensation in which it is first acknowledged.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured. The present invention provides a system for communicating a sensation.

FIG. 1 is a schematic flow diagram illustrating the method for communicating the intensity of a sensation on a sensation intensity scale (100);

FIG. 2 shows the Wong-Baker face scale™ used for the sweetness and saltiness test (200);

FIG. 3 shows the results and the significance of the sweetness test (300); and

FIG. 4 shows the results and the significance of the saltiness test (400).

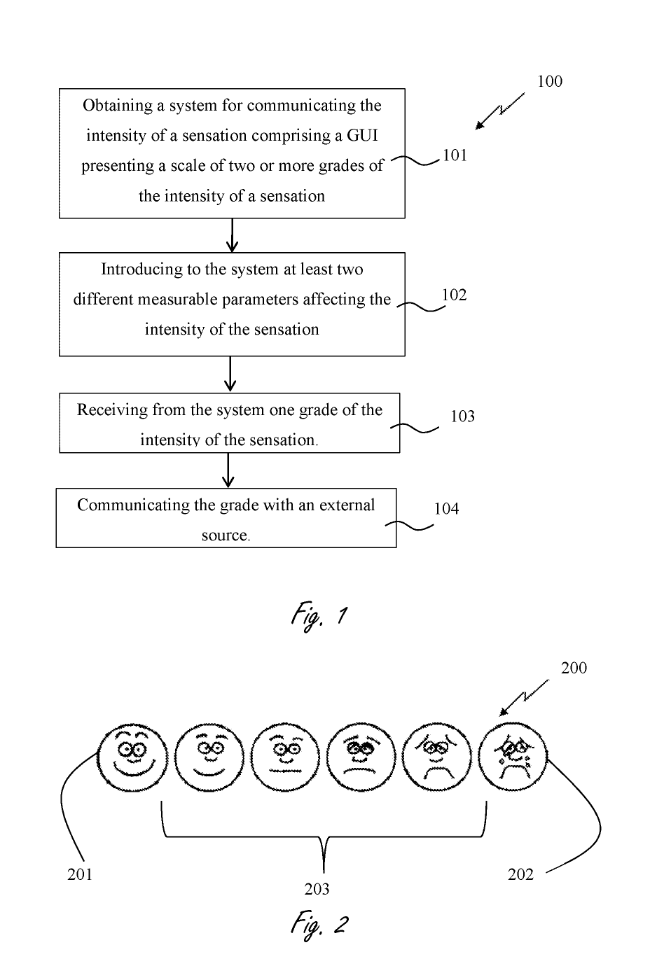

### DETAILED DESCRIPTION OF THE PREFERRED EMBODIMENT

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The term “graphical user interface (GUI)” refers hereinafter to a type of user interface that allows users to interact with electronic devices using images rather than text commands. GUIs can be used in computers, hand-held devices such as MP3 players, portable media players or gaining devices, household appliances, office, and industry equipment. The term “sensation” refers hereinafter to a mental process resulting from the immediate external stimulation of a sense organ. More particularly the term relates to the five senses (vision, taste, hearing, smell and touch), reactions to external or internal stimuli (laughter, crying, blushing . . . ) and emotions (affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear frustration, gratitude, grief, guilt, happiness, hatred, hope, horror, hostility, hurt, hysteria, indifference, interest, jealousy, joy, loathing, loneliness; love, lust, outrage, panic, passion, pity, pleasure, pride, rage, regret, relief, remorse, sadness, satisfaction, self-confidence, shame, shock, shyness, sorrow, suffering; surprise, terror; trust, wonder, worry, zeal, zest).

The term “taste” refers hereinafter to the sensation produced when a substance in the mouth reacts chemically with receptors of taste buds. Taste, along with smell (olfaction) and trigeminal nerve stimulation determines flavors, the sensory impressions of food or other substances.

The term “flavor” refers hereinafter to the sensory impression of a food or other substance, and is determined mainly by the chemical senses of taste and smell. The taste of food is limited to sweet, sour, bitter, salty, mann (savory) pungent or piquant, and metallic—the seven basic tastes

The term “sweetness” refers hereinafter to one of the five basic tastes which is almost universally regarded as a pleasurable experience. Sweetness also refers to one of the seven basic flavors. Foods rich in simple carbohydrates such as sugar are those most commonly associated with sweetness, although there are other natural and artificial compounds that are sweet at much lower concentrations, allowing their use as non-caloric sugar substitutes. Examples of foods that may be used as non-sugar sweet substitutes include saccharin, aspartame, xylitol and acesulfame potassium. Other compounds may alter perception of sweetness itself.

The term “sugar” refers hereinafter to a class of chemically-related sweet-flavored substances, most of which are used as food. They are carbohydrates, composed of carbon, hydrogen and oxygen. There are various types of sugar derived from different sources. More specifically the term relates to sucrose, lactose, fructose, maltose; glucose, galacotse, monosaccharaides, disaccharides.

The term “scale” refers hereinafter to a type of composite measure that summarizes and rank-orders several specific observations and represents some more general dimension. An index is an accumulation of scores from a variety of individual items.

The term “interval scale” refers hereinafter to a scale of measurement in which the magnitude of difference between measurements of any two units is meaningful.

The term “ratio scale” refers hereinafter to a special form of interval scale that as a true zero.

The term “ordinal scale” refers hereinafter to a scale in which one unit has more of a certain characteristic than another unit.

The term “refractometer” refers hereinafter to a device for the measurement of an index of refraction (refractometry). The index of refraction is calculated from Snell's law and can be calculated from the composition of the material using the Gladstone-Dale relation. The refractometer enables measuring sugar concentration and salinity.

The term “factorize” refers hereinafter to an action carried out on parameters measured for determining the intensity of a sensation. These actions include: summing, multiplying; dividing and subtracting the parameters as well as multiplying them by a factor and any combination of these actions.

The term “sensor” refers hereinafter to a converter that measures a physical quantity and converts it into a signal which can be read by an observer or by an instrument.

The term “Valiber” refers hereinafter to a system for communicating the intensity of a sensation on a sensation intensity scale or a measuring module for measuring at least two values of at least two different measurable parameters affecting the intensity of a sensation or An article of manufacture (AOM) for measuring at least two values of at least two different measurable parameters affecting the intensity of a sensation.

The term “Val” refers hereinafter to the unit comprising a sensation intensity scale. According to the sensation measured the Val can have different meanings For example, “Sweetness Val” is the unit for measuring the intensity of sweetness and “Joy Val” is the unit for measuring the intensity of joy.

Reference is now made to FIG. 1 which is a schematic flow diagram illustrating the method for communicating the intensity of a sensation on a sensation intensity scale (100). In the first step a system for communicating the intensity of a sensation comprising a GUI is obtained (101). The GUI can be a laptop, a computer, a cellular phone, a smartphone or any other graphical interface that enables the selection of a scale-mark on scale. In the second step at least two different measurable parameters affecting the intensity of the sensation is introduced to the system (102). The parameters can be inserted manually to the system or the system may be connected to a measuring module that measures the relevant parameters and transmits them into the system. In the next step a scale-mark on the sensation intensity scale is received (103) from the system that is a result of factorizing the parameters of the previous step. In most cases the scale will include more than two scaling scale-marks. The scale-marks can he presented as numbers presenting the intensity of a sensation in which the intensity increases or decreases as the number increases. In a more user friendly way, which may be suitable also for children, the numbers can be replaced with animated icons, such as the Wong Baker faces scale™. The scale-mark on the scale can be selected by a touch screen, through a key hoard attached or through voice command. In the last step the selected scale-mark is communicated with an external source (104). The external source can be a social network, a blog, an individual or a group of individuals.

In one embodiment of the invention the system is a smartphone receiving data regarding parameters from an electrode. For example, a person made a fresh jar of lemonade at home and now he is interested in sharing his experience with others. He wishes to communicate the sweetness intensity of the lemonade he made. He has a special electrode for measuring sweetness which he dips in the lemonade. The electrode measures several parameters known to affect sweetness: sugar concentration, temperature, acidity and viscosity. All these parameters are transmitted to his smartphone by connecting it to the electrode. The smartphone is able then to factorize from these parameters the sweetness intensity on a Wong-Baker Face scale™. In the factorizing procedure the different parameters receive different weight. The main parameter is the sugar concentration and it may receive 50% of the weight. The rest of the parameters share in an equal manner the rest of the 50%. Once the intensity is factorized it can be shared, for example, on a lemonade making forum. People viewing the post regarding the lemonade sweetness will know to set these parameters in order to achieve the same sweetness or they will have a reference point for setting the sweetness intensity suitable for them.

In another embodiment of the invention the sweetness intensity scale is a ratio scale comprised of scale-marks which are differentiated by Val units which describes the sweetness of a clear solution of water with sucrose concentration of 3.423 g/liter at 20° C., pH 7. The reason this unit was selected is that sensitivity threshold towards sweetness of a human being is 4 g sucrose per 1 liter water. The meaning of 0 is the sweetness of pure water in the disclosed conditions.

The difference between describing sweetness and sugar concentration is that sweetness is subjective while sugar concentration is objective. A cup of coffee with two spoons of sugar might be good for one person but too sweet for a second. Sweetness can be affected by factors affecting the solution (e.g. temperature, viscosity) or factors concerning the person tasting the solution (e,g. gender, age). Both types of factors can be factorized to give a more objective degree of taste or to normalizing the sweetness according to the conditions of the solution or the person tasting it. If additional parameters are added to the sugar concentration parameter, a much more accurate scale of sweetness can be built.

In another embodiment the system has a feedback feature that would be able to correct or to give instructions how to correct the intensity of a sensation. For example, a person drinks his coffee in the sweetness of 2.5 Val. He measures the sweetness of coffee served to him in a café with a system for communicating the intensity of sweetness which tells him the sweetness of his drink. The feedback feature in the system can also give him directions how to change the sweetness according to his preferences.

In another embodiment the measuring module can be embedded within an item like a dressing item, or cutlery, tableware, kitchenware, jewelry, electronic or electric devices. For example a device measuring parameters for determining sweetness embedded within a straw can give the sweetness of the solution it is dipped in. In another example the measuring module can be embedded within a hat and measure parameters for determining the degree of happiness of a person—like respiratory rate, intensity of laughter sound and other parameters being noticed in the facial area reflecting happiness. Other sensations can be also measured in a similar way.

In another embodiment the measuring module measures the parameters which determine the intensity of the sensation are measured in a time resolved manner. For example, the sweetness of an iced-drink can be measured by a straw with a sensor adapted to measure sweetness in a time resolved manner. When time passes the ice melts and dilutes the drink and the sweetness is decreased.

### EXAMPLE 1

Thirty individuals in the age range of 25-55 were asked to taste a set of solutions with different concentrations of sugar and to scale-mark their sweetness on a scale of 6 faces (200) known as the Wong-Baker Face scale™. The happiest face (201) represented the sweetest taste and the crying face the least sweet (202). All faces in between (203) represented intermediate degrees of sweetness.

The solutions were randomly numbered from 1-8 and they contained concentrations of 0, 4, 40, 80, 160, 320 1000 and 2000 g/L sugar. Each of the participants tasted 5 of the solutions in a random manner and scale-marked their sweetness on the Wong-baker Face scale™.

The results on the scale were transformed into numbers—the least sweet solution was numbered 1 and the sweetest solution 6. An average of the scale-marks were made on each of the solutions and the Tuky and Kramer test was applied to the results to check their significance using JMP IN software (version 5.1).

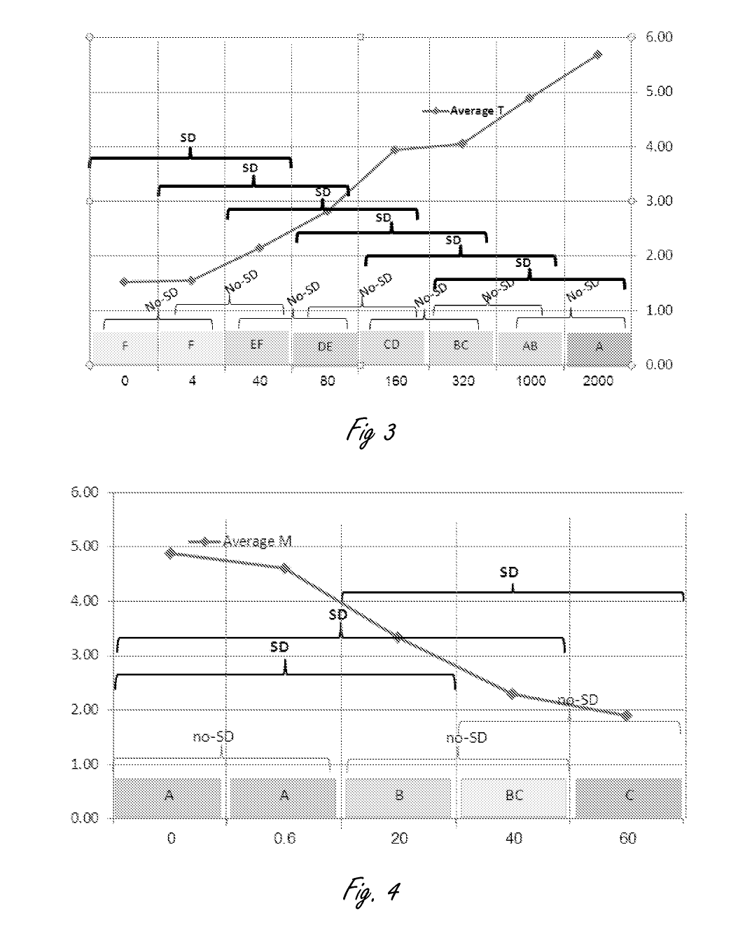

The results are summarized in FIG. 3 (300). It can be seen that a significant difference was observed between 0-40, 4-80, 40-160, 80-320, 160-1000 and 320-2000 g/L (marked by SD). As can be seen it is hard to differentiate between the low sugar concentrations and the high sugar concentrations. The intermediate concentrations are quite successfully differentiates. We are positive that similar experiments with more participants will improve the results significantly.

### EXAMPLE 2

Thirty individuals in the age range of 25-55 were asked to taste a set of solutions with different concentrations of salt (NaCl) and to scale-mark their saltiness on a scale of 6 faces (200) known as the Wong-Baker Face scale™. The happiest face (201) represented the least salty taste and the crying face the most salty (202). All faces in between (203) represented intermediate degrees of saltiness.

The solutions were randomly numbered from 1-8 and they contained concentrations of 0, 0.6, 20, 40 and 60 salt. Each of the participants tasted all the solutions in a random manner and scale-marked their saltiness on the Wong-baker Face scale™.

The results are summarized in FIG. 4 (400). It can be seen that a significant difference was observed between 0-20, and 20-60 g/L (marked by SD).

We are positive that similar experiments with more participants will improve the results significantly.

### EXAMPLE 3

Val is a measurement unit for scaling senses. In common to all Val scales are: (1) the scale is a ratio scale, meaning that it can get the value zero; (2) It has a sensitivity threshold point—the point that the sense starts to be noticed; (3) the scale and the scale units have the ability to differentiate and define increasing\decreasing of the intensity of the measured sensation; and (4) there is a saturation point in which the intensity of the sensation can no longer be increased.

The Val (derived from Valiber) unit presents the intervals of the intensity of the measured sensation. The point that the intensity of the sense starts indicating its existence (sensitivity threshold) is defined as 1 Val. Taking in consideration that this point can be different from one person to another, 1 Val is defined as the average threshold point. The Val scale is linear meaning that 2 Val has a value double of 1 Val and so on.

Taste, is the sensory impression of food or other substances on the tongue and is one of the five traditional senses. It the sensation produced when a substance in the mouth reacts chemically with taste receptor cells located on taste buds. The sensation of taste can be categorized into five basic tastes: sweetness, sourness, saltiness, bitterness, and umami. Table 1 provides a summary of the five tastes along with a representative compound, its threshold concentration that above it is noticeable and the Val units corresponding to this concentration.

TABLE 1

| Sense | | | |
|---|---|---|---|
| Reference | Compound | Threshold Molar | 1 Val (g/liter) |
| Sweetness | Sucrose | 0.010000 | 3.423 |
| Saltiness | Sodium Chloride | 0.010000 | 0.584 |
| Sourness | Citric acid | 0.000900 | 0.079 |
| Bitterness | Quinine | 0.000008 | 0.002 |
| Umami | Monosodium glutamate | 0.000700 | 0.118 |

### EXAMPLE 4

Sweetness

Sweetness is produced by the presence of sugars and a few other substances. It is known that Sucrose is one of the main factors that create sweetness sense. Therefore the reference for defining the units of “sweetness Val” the reference will be sucrose solutions in water at 25°C., pH 7.

Determining the reference to sweetness Val is as follows:

It is known that 10 milimolar (mM) of Sucrose is the threshold point of sweetness in which taste buds receptors begin to indicate sweetness, in a cup (200 ml) 10 mM equals to about ⅙ teaspoon of sucrose (sugar), according to the calculation brought in Table 2:

TABLE 2

| Molecular formula | C₁₂H₂₂O₁₁ | |
|---|---|---|
| Molar mass | 342.30 | g/mol |
| 10 mM (threshold) | 3.423 | g/liter |
| Cup - volume | 200 | ml |
| 10 mM sugar in a cup | 0.6846 | g |

| | |
|---|---|
| Teaspoon (4.2 g) | 0.6846/4.2 = 0.163 spoons/cup |

This means that, on average, people will start feeling sweetness while testing a cup of water with 0.163 spoons of sugar.

Therefore, the Val unit in a sweetness scale is =3.423 g/L.

Table 3 discloses the sweetness of various compounds relatively to sucrose and their Valiber value.

TABLE 3

| | | Sweetness relatively | |
|---|---|---|---|
| Name | Type of compound | to sucrose | Val |
| Lactose | Disaccharide | 0.16 | 21.37 |
| Maltose | Disaccharide | 0.33-0.45 | 10.36-7.60 |
| Glucose | Monosaccharide | 0.74-0.8 | 4.62-4.27 |
| Sucrose | Disaccharide | 1.00 (reference) | 3.42 |
| Fructose | Monosaccharide | 1.17-1.75 | 2.92-1.94 |
| Sodium | Sulfonate | 26 | 0.13 |
| cyclamate | | | |
| Steviol | Glycoside | 40-300 | 0.085-0.011 |
| glycoside | | | |
| Aspartame | Dipeptide methyl ester | 180-250 | 0.019-0.013 |
| Sodium | Sulfonyl compound | 300-675 | 0.011-0.005 |
| saccharin | | | |
| Thaumatin | Protein | 2000 | 0.0017 |

‘Sweetness Valiber’ is a measuring tool that measures sweetness. When it indicates 1 Val it indicates the existence of a sweetness factor in a degree as shown in Table 1.

The SCAA defines the gold standard for a cup of coffee as 6 oz (177.4 cc) but most table settings come with cups that hold approximately 6-9 fluid oz (177.4 cc -266.2 cc). In order to make number rounded and simple to use we set the size of a Cup of coffee as 204.5 cc and the size of teaspoon (TS) as 4.2g of sugar. Table 4 defines the sweetness in Val units of different sucrose solutions (the concentrations are given in teaspoons/204.5 cc).

TABLE 4

| Sugar Tea Spoons | Val |
|---|---|
| 0.5 | 3 |
| 1.0 | 6 |
| 1.5 | 9 |
| 2.0 | 12 |
| 2.5 | 15 |
| 3.0 | 18 |
| 3.5 | 21 |
| 4.0 | 24 |
| 4.5 | 27 |
| 5.0 | 30 |
| 5.5 | 33 |
| 6.0 | 36 |

When a person or a device intends to assess sweetness he refers to this table. The Valiber device will be able to assess the sweetness of solutions of other sweet substances in different conditions (temperature, acidity, color and other parameters affecting sweetness) and normalize them into the reference of table 4.

### EXAMPLE 5

Saltiness

Saltiness is a taste produced primarily by the presence of sodium ions. Other ions of the alkali metals group also taste salty, but the further from sodium the less salty the sensation is. The size of lithium and potassium ions most closely resemble those of sodium and thus the saltiness is most similar. The saltiness of substances is rated relative to sodium chloride (NaCl).

TABLE 5

| # | Substances | | Relation Value |
|---|---|---|---|
| 1 | Sodium iodide | NaI | 0.35 |
| 2 | Sodium bromide | NaBr | 0.40 |
| 3 | Lithium chloride | LiCl | 0.40 |
| 4 | Potassium chloride | KCl | 0.60 |
| 5 | Sodium chloride | NaCl | 1.00 |
| 6 | Calcium chloride | CaCl2 | 1.00 |
| 7 | Sodium fluoride | NaF | 2.00 |
| 8 | Ammonium chloride | NH4Cl | 2.50 |

Table 5 presents the saltiness of different substances relatively to NaCl.

### EXAMPLE 5

Sourness

Sourness is the taste that detects acidity.

Table 6 presents the sourness of different substances relatively to Citric Acid.

TABLE 6

| # | Substances | | Relation Value |
|---|---|---|---|
| 1 | Carbonic acid | | 0.13 |
| 2 | Citric acid | | 1.00 |
| 3 | Acetic acid | | 1.20 |
| 4 | Potassium H tartrate | | 1.26 |
| 5 | Malic acid | | 1.30 |
| 6 | Tartaric acid | | 1.52 |
| 7 | Lactic acid | | 1.85 |
| 8 | Acetoacetic acid | | 1.85 |
| 9 | Chloracetic acid | MCA | 1.96 |
| 10 | Hydrochloric acid | HCl | 2.17 |
| 11 | Formic acid | | 2.39 |

TABLE 7

| Val | C(HCl)[M] | pH |
|---|---|---|
| 1 | 9.00E−04 | 3.0458 |
| 2 | 1.80E−03 | 2.7447 |
| 3 | 2.70E−03 | 2.5686 |
| 4 | 3.60E−03 | 2.4437 |
| 5 | 4.50E−03 | 2.3468 |
| 6 | 5.40E−03 | 2.2676 |
| 7 | 6.30E−03 | 2.2007 |
| 8 | 7.20E−03 | 2.1427 |
| 9 | 8.10E−03 | 2.0915 |
| 10 | 9.00E−03 | 2.0458 |
| 11 | 9.90E−03 | 2.0044 |
| 12 | 1.08E−02 | 1.9666 |
| 13 | 1.17E−02 | 1.9318 |
| 14 | 1.26E−02 | 1.8996 |
| 15 | 1.35E−02 | 1.8697 |
| 16 | 1.44E−02 | 1.8416 |
| 17 | 1.53E−02 | 1.8153 |
| 18 | 1.62E−02 | 1.7905 |
| 19 | 1.71E−02 | 1.7670 |
| 20 | 1.80E−02 | 1.7447 |

Table 7 presents Val values Vs, pH values

### EXAMPLE 6

Bitterness

Bitterness is the most sensitive of the tastes, and many perceive it as unpleasant, sharp, or disagreeable, but it is sometimes desirable and intentionally added via various bittering agents. Common bitter foods and beverages include coffee, unsweetened cocoa, South American mate, bitter gourd, olives, citrus peel, many plants in the Brassicaceae family, dandelion greens, wild chicory, and escarole. Alcoholic beverages are in general described as tasting bitter due to ethanol.

Table 8 presents the bitterness of different substances relatively to Quinine

TABLE 8

| # | Substances | Value |
|---|---|---|
| 1 | Morphine | 0.02 |
| 2 | Cocaine | 0.02 |
| 3 | Atropine | 0.13 |
| 4 | Pilocarpine | 0.16 |
| 5 | Veratrine | 0.20 |
| 6 | Caffeine | 0.40 |
| 7 | Phenylthiourea | 0.90 |
| 8 | Quinine | 1.00 |
| 9 | Nicotine | 1.30 |
| 10 | Strychnine | 3.10 |
| 11 | Brucine | 11.00 |

1-87. (canceled)

88. A system for communicating the intensity of a taste on a taste intensity scale, characterized by:
a. a receiving module for obtaining at least two values of at least two different measurable parameters affecting said taste;
b. a processing module for factorizing said at least two values of different measurable parameters affecting said taste into a scale-mark on said intensity scale; said intensity scale is comprised of two or more scale-marks;
c. a graphical user interface (GUI) for presenting said taste intensity scale and said scale-mark; and
d. a communication module for sharing said scale-mark on said intensity scale.

89. The system of claim 88, wherein at least two of: (a) said receiving module; (b) said processing module; (c) said GUI and (d) said communication module, are the same device.

90. The system of claim 88, further characterized by at least one measuring module for measuring said at least two different measurable parameters affecting said taste.

91. The system of claim 90, wherein said at least one measuring module is selected from a group of electronic or electric measuring devices comprising of refractometer, VU meter, voltmeter, video signal generator, vectorscope, wattmeter, tube tester, transistor tester, sweep generator, pH electrode, spectrum analyzer, signal generator, signal analyzer, Q meter, psophometer, oscilloscope, ohmmeter, network analyzer, microwave power meter, multimeter, LCR meter, frequency counter, electricity meter, distortionmeter, capacitance meter, ammeter, thermometer, motion detector, metal detector; and any combination thereof.

92. The system of claim 90, wherein said measuring module is connected with said processing module by a connection mean selected from a group consisting of: (a) remote; (b) direct; and any combination thereof.

93. The system of claim 88, wherein said at least two values of said at least two different measurable parameters affecting said taste are inserted into said receiving module of said system manually or automatically or are directly transmitted to said receiving module through said at least one measuring module in a manner selected from a group consisting of: cable; WiFi; Bluetooth, IR, radio; and any combination thereof.

94. The system of claim 88, wherein said communication module or GUI is selected from a group consisting of: MP3 player; cellular phone; smartphone; tablet; laptop; computer; and any combination thereof.

95. The system of claim 88, wherein said taste is selected from a group consisting of sweetness, sourness, bitterness, saltiness, umami, pungent or piquant, and metallic and any combination thereof.

96. The system of claim 95, wherein said taste is sweetness.

97. The system of claim 96, wherein said at least two different measurable parameters are selected from a group consisting of sugar concentration; temperature; acidity; color; color intensity; opacity; specific gravity; viscosity; and any combination thereof.

98. The system of claim 88, additionally comprising a feedback module that directs the user how to change at least one of said at least two values of said at least two different measurable parameters to change said intensity of said taste in a specific way.

99. The system of claim 88, wherein said intensity scale is a Val scale.

100. A measuring module for measuring at least two values of at least two different measurable parameters affecting the intensity of a taste, comprising:
a. at least one sensor for obtaining said at least two values; and
b. at least one transmitting component for transferring said at least two values;
wherein said intensity of said taste is factorized from said at least two values.

101. The measuring module of claim 100, wherein the measuring module is housed in an article of manufacture (AOM).

102. The measuring module of claim 101, wherein the AOM is selected from the group consisting of: dressing item, cutlery, tableware, kitchenware, jewelry, and electronic or electric device.

103. The measuring module of claim 100, wherein said at least one sensor is selected from a group of electronic or electric measuring devices comprising of refractometer, VU meter, voltmeter, video signal generator, vectorscope, wattmeter, tube tester, transistor tester, sweep generator, pH electrode, spectrum analyser, Signal generator, Signal analyzer, Q meter, psophometer, oscilloscope, ohmmeter, network analyzer, microwave power meter, multimeter, LCR meter, Frequency counter, electricity meter, distortionmeter, capacitance meter, ammeter, thermometer, motion detector, metal detector; and any combination thereof.

104. The measuring module of claim 100, wherein said taste is selected from a group consisting of sweetness, sourness, bitterness, saltiness, umami, pungent or piquant, and metallic and any combination thereof.

105. The measuring module of claim 104, wherein said taste measured by said at least one sensor is sweetness.

106. The measuring module of claim 100, wherein said intensity scale is a Val scale.

107. The method of claim 88, wherein the communication module is capable of sharing said scale-mark on said intensity scale with an external source selected from the group consisting of social network; blog; internet site; individual; group of individuals; and any combination thereof.
